(19) United States
(12) Patent Application Publication
(10) Pub. No.: US 2012/0041953 A1
(43) Pub. Date: Feb. 16, 2012

(54) TEXT MINING OF MICROBLOGS USING LATENT TOPIC LABELS

(75) Inventors: Susan Theresa Dumais, Kirkland, WA (US); Daniel Ramage, Palo Alto, CA (US); Daniel John Liebling, Seattle, WA (US); Steven Mark Drucker, Bellevue, WA (US)

(73) Assignee: Microsoft Corporation, Redmond, WA (US)

(21) Appl. No.: 12/857,518

(22) Filed: Aug. 16, 2010

(51) Int. Cl. G06F 17/30

(52) U.S. Cl. 707/739; 707/776; 707/E17.014

(57) ABSTRACT

A latent topic labels text mining system and method to mine and analyze the content of textual data. Embodiments of the system and method are particularly well suited for use on microblog data to help people identify posts they want to read and to find people that they want to follow. Embodiments of the system and method use a modified Labeled LDA technique (called an L+LDA technique) that analyzes content using a combination of labeled and latent topics. The resultant data is assigned labels one of four labels to generate a lower-dimensional representation of the data that the individual words in a microblog post. This learned topic representation is used to characterize, summarize, filter, find, suggest, and compare the content of microblog posts. Embodiments of the system and method also include visualization techniques such as a tag cloud visualization that is used to visualize microblogging data.

### BACKGROUND

As more text becomes available online, improved text mining techniques are desired to discover, explore, and understand trends in the text data. One recent development is that a large fraction of this text has been annotated to contain open-domain tags from content creators and consumers alike. As web technologies evolve, the amount of human-provided annotations on that text increases and becomes a source of information that text mining techniques can leverage.

One forum in which text mining can be useful is in mining microblogs. A microblog is a form of blog (“blog” is a contraction of the phrase “web log”). As the name implies, a microblog differs from a traditional blog in that its content is typically much smaller, in both actual size and aggregate file size. A typical microblog entry may be a short sentence fragment about what a person is doing at the moment or may be related to short comment on a specific topic (such as computer science).

Most users' interaction with microblog sites is still primarily focused on identifying individuals to follow. There are limited capabilities to specify topics of interest. In other words, microblogs are focused on “people I want to follow” and not “topics want read about.” Thus, if someone that a person follows is talking 50% of the time about computer science topics and the rest of the time about their personal life, someone interested in just the computer science content must follow everything from the author even though they are interested in just a part of the content.

Text mining of microblogs poses several challenges. Posts are short (usually 140 characters or less) with language unlike the standard written English on which many supervised models in machine learning and natural language processors are trained and evaluated. Effectively modeling content on microblogs requires techniques that can readily adapt to the data at hand and require little supervision.

One such unsupervised latent variable topic model is the popular unsupervised model Latent Dirichlet Allocation (LDA). Latent variable topic models have been applied widely to problems in text modeling and require no manually constructed training data. LDA models distill collections of text documents into distributions of words that tend to co-occur in similar documents. However, because it is unsupervised the LDA technique can miss some important information. Another technique, Labeled LDA, extends the LDA technique by incorporating supervision in the form of implied microblog-level labels where available. This enables explicit models of text content associated with labels. In the context of microblogs, these labels include things such as hashtags, replies, emoticons, and the like. However, a fully-supervised version of LDA that requires one or more labels for every post would be unfeasible because of the burden it would impose on users.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the latent topic labels text mining system and method analyze the content of textual data. Embodiments of the system and method are particularly well suited for use on microblog data to help people identify posts they want to read in addition to people they want to follow. Embodiments of the system and method can work for any type of text (such as blogs, e-mail, newswire text, etc).

Embodiments of the system and method use an application of Labeled Latent Dirichlet Allocation (Labeled LDA) technique with latent topic labels. This technique is called the L+LDA technique for short, indicating that this technique is an augmented version of the Labeled LDA that includes the latent topic labels. Basically, the L+LDA technique begins with the Labeled LDA technique using user-generated labels (such as #hash, @user, emoticon, and so forth) where they exist and augments this technique by also adding K latent labels to every document. This makes the L+LDA technique different from the traditional Labeled LDA technique.

Embodiments of the system and method analyze content using a combination of labeled and unlabeled (or latent) dimensions. A “dimension” as used in this document means a clustering or grouping of words. A labeled dimension is a grouping of words made by the machine learning technique that is supervised using user-assigned labels. In contrast, a latent (or unlabeled) dimension is a grouping of words by the machine learning technique that is unsupervised.

Embodiments of the system and method take labels that authors (or readers) apply to subsets of the posts as input. These user-provided labels can include conventions like a hashtag label (which is a microblog convention that is used to simplify search, indexing, and trend discovery) that is used in some posts, and an emoticon-specific label that can be applied to posts. In addition, @user labels can be applied to posts that address a user using the @user convention.

Embodiments of the system and method also characterize, summarize, filter, find, suggest, and compare the content of microblog posts. By aggregating across the whole dataset, embodiments of the system and method can present a large-scale view of what authors post on a microblogging site. In addition, embodiments of the system and method collect data in real time to suggest and find people to follow on a microblogging site.

Visualization techniques are used by embodiments of the system and method to facilitate the visualization of organized data mined from the microblog posts. One example of a visualization technique is a tag cloud-based visualization that is used to summarize microblogging data. The tag cloud-based visualization is a cloud of words where the size of each word represents the word's importance relative to the other words in the cloud. The tag-based cloud visualization is used to illustrate the words and their relative importance within a topic model. In some embodiments, the tag cloud-based visualization is generated across a set of microblog posts (such as recent microblog posts from a user, or posts returned for a search query) and shading is used visualize whether this set of posts uses words in the learned topic. Thus, using a variety of visualization methods (such as word size and word shading) the visualization techniques (such as tag cloud-based visualizations) can be used to visually characterize and contrast users.

It should be noted that alternative embodiments are possible, and that steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating a general overview of embodiments of a latent topic labels text mining system and method implemented on a computing device.

FIG. 2 is a flow diagram illustrating the general operation of embodiments of the latent topic labels text mining system shown in FIG. 1.

FIG. 3 illustrates a Bayesian graphical model and generative process for embodiments of the L+LDA model and analysis module shown in FIG. 1.

FIG. 4 is a flow diagram illustrating the operational details of embodiments of the 4S label module shown in FIG. 1.

FIG. 5 is a flow diagram illustrating the operational details of embodiments of the data organization module shown in FIG. 1.

FIG. 6 is a flow diagram illustrating the operational details of embodiments of the visualization module shown in FIG. 1.

FIG. 7 illustrates an example of a suitable computing system environment in which embodiments of the latent topic labels text mining system and method shown in FIGS. 1-6 may be implemented.

### DETAILED DESCRIPTION

In the following description of embodiments of the latent topic labels text mining system and method reference is made to the accompanying drawings, which form a part thereof, and in which is shown by way of illustration a specific example whereby embodiments of the latent topic labels text mining system and method may be practiced. It is to be understood that other embodiments may be utilized and structural changes may be made without departing from the scope of the claimed subject matter.

### I. System Overview

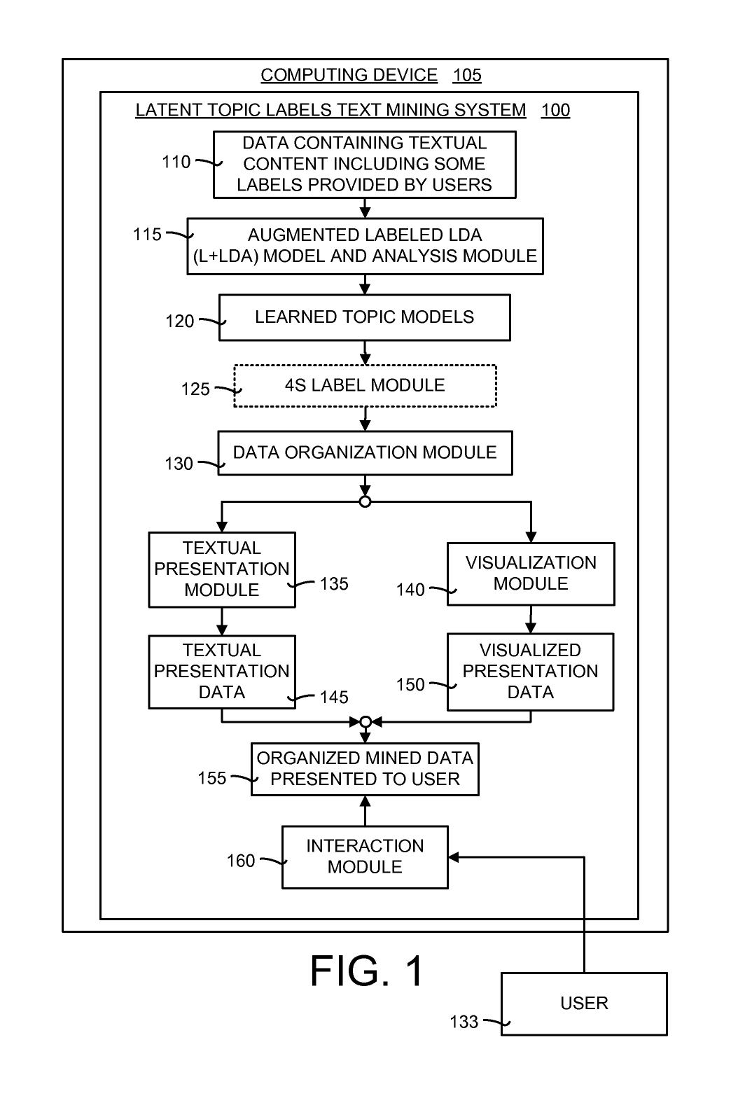

FIG. 1 is a block diagram illustrating a general overview of embodiments of a latent topic labels text mining system 100 and method implemented on a computing device 105. In general, embodiments of the latent topic labels text mining system 100 and method mine a block of data containing text to characterize, summarize, filter, find, suggest, and compare the text contained therein. In addition, embodiments of the latent topic labels text mining system 100 and method visualize the mined data and facilitate a user's interaction with the visualized data.

More specifically, embodiments of the latent topic labels text mining system 100 shown in FIG. 1 obtain data that contains textual content including some labels provided by users 110. In some embodiments this textual data includes microblog posts from a microblogging site, and in some embodiments these labels provided by users include #hashtags, @user, and emoticons. Embodiments of the system 100 and method also include an augmented labeled LDA (L+LDA) model and analysis module 115. The L+LDA model begins with the Labeled LDA technique using user-generated where they exist and augments this technique by also adding K latent labels to every document. Module 115 processes the input data and outputs learned topic models 120 that are a learned topic representation of the data. Embodiments of the system 100 and method also include an optional 4S label module 125. This is an optional module as denoted by the dashed line around the module 125 in FIG. 1. Embodiments of the optional manual label module 125 provide a manual grouping of topics that were learned during the L+LDA processing and give them a “4S label.”

In particular, embodiments of the module 125 take the latent and labeled topics that were learned during the L+LDA processing and provide a manual grouping of these topics and associate the topics with a 4S label. As explained in detail below, the phrase “4S label” refers to the fact that there are four high-level labels that begin with the letter “s”, namely substance, social, status, and style labels. It should be noted that the 4S labels are only one embodiment of several different embodiments that may use these manually-applied labels. For example, instead of there being only four 4S labels there could be a greater or lesser number of labels. In addition, the labels do not have to begin with the letter “s” and could be any label name imaginable.

A data organization module 130 receives the learned topic representation of the data 120 (and in some cases the 4S labels generated by embodiments of the 4S label module 125) and organizes the data representations to allow characterizing, summarizing, filter, comparing, or finding of data. In addition, embodiments of the data organization module 130 can provide to a user 133 a list of persons to follow on a microblog site based on information provided by the user 133.

Embodiments of the latent topic labels text mining system 100 and method also include a textual presentation module 135 and a visualization module 140 for presenting the organized data that is mined from the data containing textual content 110 to a user 133. The textual presentation module 135 takes the organized data and presents it to the user 133 in a textual fashion as textual presentation data 145. The visualization module 140 takes the organized data and presents it to the user 133 in a visual manner as visualized presentation data 150.

Organized mined data 155 thus is presented to the user 133 either in textual form, visual form, or some combination of the two. Embodiments of the latent topic labels text mining system 100 and method also include an interaction module 160. The interaction module 160 facilitates interaction between the user 133 and the textual presentation data 145 and the visualized presentation data 150. In other words, through the interaction module 160 the user 133 can interact and change preferences, interests, and desired outcomes of the textual presentation data 145 and the visualized presentation data 150.

### II. Operational Overview

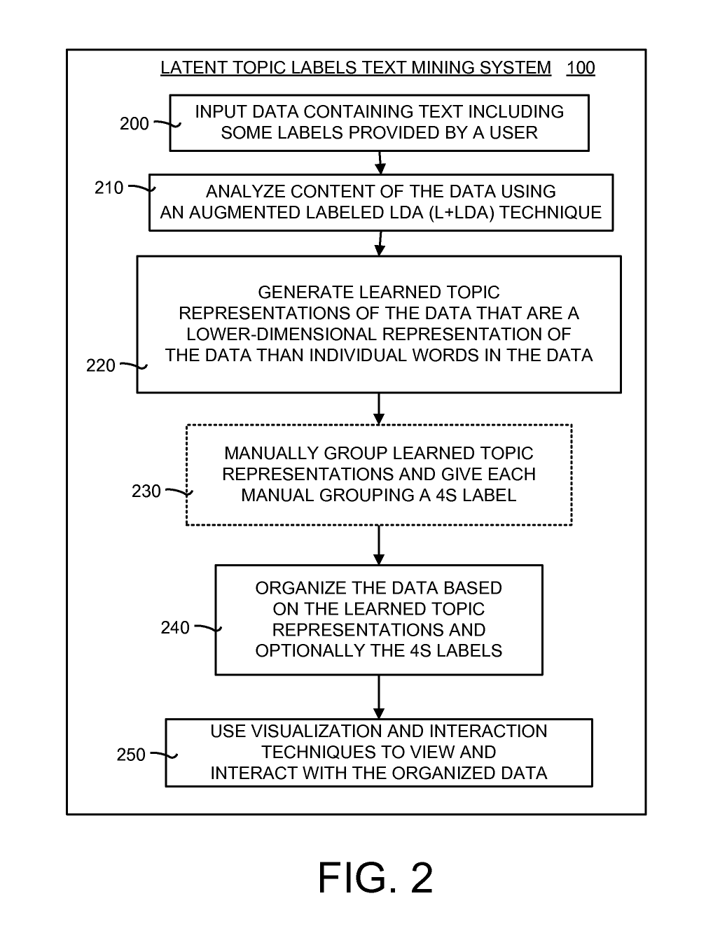

FIG. 2 is a flow diagram illustrating the general operation of embodiments of the latent topic labels text mining system 100 shown in FIG. 1. Referring to FIG. 2, the method begins by inputting data containing text and any labels provided by a user (box 200). In some embodiments this data contains microblog posts. Next, embodiments of the method analyze the content of the data, including both the text and any labels provided by the user that exist, using an augmented Labeled LDA (L+LDA) technique (box 210). This L+LDA technique is described in detail below. The L+LDA processing generates learned topic representations of the data (box 220). These learned topic representations are a lower-dimensional representation of the data. A lower-dimensional representation of the data means that there are fewer learned topics than individual words in the data. For example, a lower-dimensional representation of a dataset of 5,000,000 words may be grouped into 2,000 topics.

Next, there is the option of adding 4S labels after the PLDA analysis to facilitate presentation and interpretation. In particular, as shown in FIG. 2, embodiments of the method allow an operator to manually group learned topic representations and give each grouping a 4S label (box 230). Note that this is an optional process that may be performed after the L+LDA processing. This is denoted as an optional process in FIG. 2 by the dashed line. Next, embodiments of the method organize the data based on the learned topic representations and in some cases the 4S labels (since the 4S labels are optional) (box 240). This organized data can be organized to characterize, compare, filter, find, and suggest. Embodiments of the method then can use visualization and interaction techniques to view and interact with the organized data (box 250).

### III. System and Operational Details

Embodiments of the latent topic labels text mining system 100 and method provide the efficient and effective mining of textual data. Embodiments of the system 100 and method are especially well-suited for use in the text mining of microblog posts. The system and the operational details of embodiments of the latent topic labels text mining system 100 and method now will be discussed. These embodiments include embodiments of the augmented Labeled LDA (L+LDA) model and analysis module 115, 4S label module 125, data organization module 130, visualization module 140, and interaction module 160. The system and operational details of each of these modules now will be discussed in detail.

### III.A. L+LDA Model and Analysis Module

Embodiments of the latent topic labels text mining system 100 and method can both adapt to trends in the data as well as model observed labels of interest. Embodiments of the latent topic labels text mining system 100 and method include an augmented Labeled Latent Dirichlet Allocation (L+LDA) model and analysis module 115 that includes a generative model for a collection of labeled documents.

Embodiments of the L+LDA model and analysis module 115 use an augmented Labeled Latent Dirichlet Allocation (LDA) technique to model the textual content on microblogs (and other text-based sites). This augmented Labeled LDA technique is called the L+LDA technique. The L+LDA technique is based on latent variable topic models like traditional LDA.

Traditional LDA is an unsupervised model that discovers latent structure in a collection of documents by representing each document as a mixture of latent topics. Each topic is itself represented as a distribution of words that tend to co-occur. The LDA technique can be used to discover large-scale trends in language usage (what words end up together in topics) as well as to represent documents in a low-dimensional topic space.

The Labeled LDA technique is an extension of traditional LDA that incorporates supervision where available. Mathematically, labeled LDA assumes the existence of a set of labels Λ, each characterized by a multinomial distribution βₖ for k∈1 . . . |Λ| over all words in the vocabulary. The model assumes that each document d uses only a subset of those labels, denoted Λ_{d}⊂Λ, and that document d prefers some labels to others as represented by a multinomial distribution θ_{d} over Λ_{d}. Each word w in document d is picked from one of that document's label's word distributions (in other words, from β_{z} for some z∈Λ_{d}. The word is picked in proportion both to how much the enclosing document prefers the label θ_{d,z} and to how much that label prefers the word β_{z,w}. In this way, the Labeled LDA technique can be used for credit attribution, which means that it can attribute each word in a document to a weighted mix of the document's labels. Other words in the document help disambiguate between label choices.

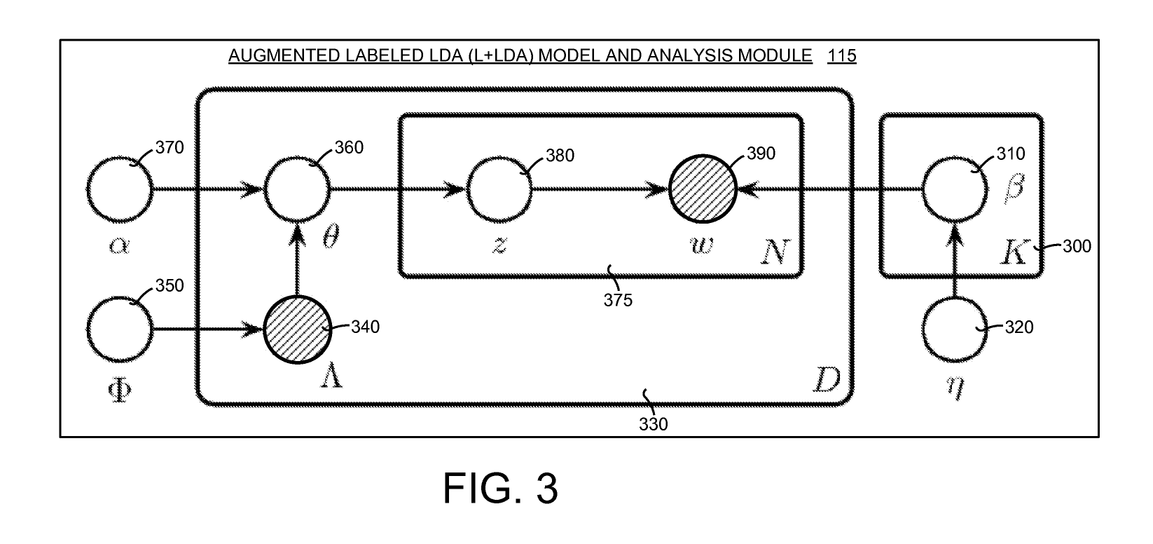

FIG. 3 illustrates a Bayesian graphical model and generative process for embodiments of the L+LDA model and analysis module shown 115 in FIG. 1. In particular, referring to FIG. 3, for each topic k in 1 . . . K 300, a multinomial distribution βₖ 310 is drawn from a symmetric Dirichlet prior β320. Next, for each document d in 1 . . . D 330, the following is performed. First, a label set Λ_{d} 340 is built that describes the document from a deterministic prior φ350. Second, a multinomial distribution θ_{d} 360 is selected over the label set Λ_{d} 340 from a symmetric Dirichlet prior α370.

Third, for each word position i1 . . . N 375 in the document d, the following is performed. First a label z_{d,i} 380 is drawn from label multinomial distribution θ_{d} 360. Second, a word w_{d,i} 390 is drawn from the word multinomial distribution β_{z} 310. Thus, this generative process assumption and approximate inference algorithm is used to reconstruct the per-document distributions θ370 over labels and the per-topic (and therefore per-class) distributions β310 over words, starting from only the documents themselves.

The advantage of our extension of the Labeled LDA technique is that a collection of microblog posts can be modeled as a mixture of some labeled dimensions as well as the traditional latent ones like those discovered by the LDA technique. Our extension of the Labeled LDA technique models K latent topics as labels named “Topic 1” through “Topic K” which are assigned to every post in the collection. If no other labels are used, this label assignment strategy makes the Labeled LDA technique mathematically identical to traditional LDA with K topics. However, the Labeled LDA technique allows the freedom of introducing labels that apply to only some subsets of posts so that the model can learn sets of words that go with particular labels (like hashtags).

The labels provided by users in microblog posts can help quantify broad trends and help uncover specific, smaller trends. For example, one label is the hashtag label. A hashtag is a microblog convention that is used to simplify search, indexing, and trend discovery. Users include specially-designed terms that start with “#” into the body of each post. For example, a post about a job listing might contain the term “#jobs.” Treating each hashtag as a label applied only to the posts that contain it allows the discovery of words that are uniquely associated with each hashtag.

Several others types of labels may be used to label the data prior to L+LDA processing. In particular, emoticon-specific labels can be applied to posts that use any of a set of nine canonical emoticons: smile, frown, wink, big grin, tongue, heart, surprise, awkward, and confused. Canonical variations may be collapsed (for example, −] and :-) are mapped to :)). The @user labels can be applied to posts that address any user as the first word in the post. Question labels can be applied to posts that contain a question mark character. Because the emoticons, @user, reply, and question labels are relatively common, each of these labels may be factored into sub-variants (such as “:)-0” through “:)-9”) in order to model natural variation in how each label is used.

### III.B. 4S Label Module

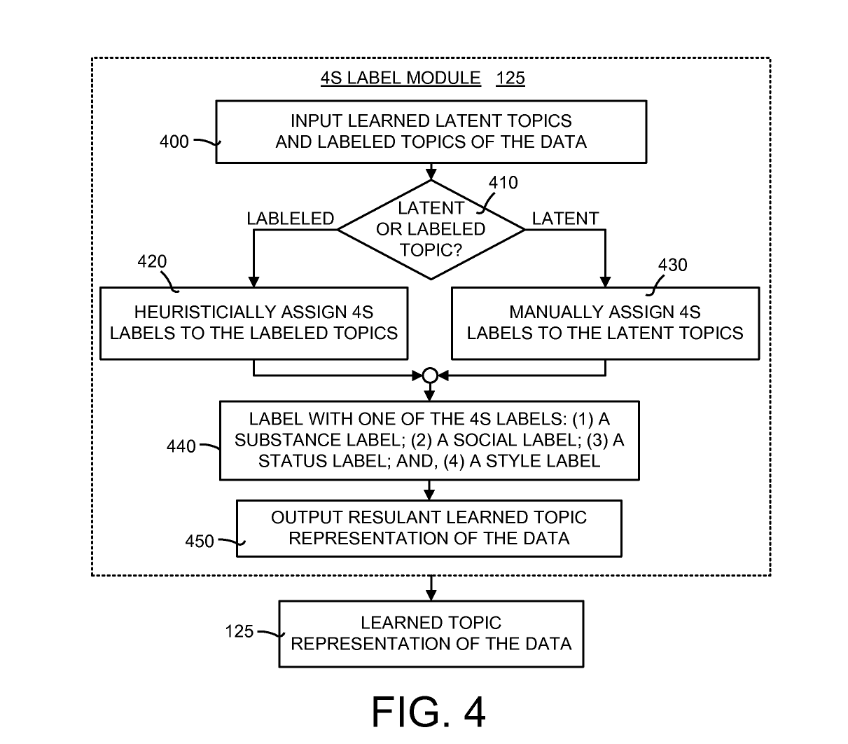

Embodiments of the latent topic labels text mining system 100 and method include an optional 4S label module 125. FIG. 4 is a flow diagram illustrating the operational details of embodiments of the 4S label module 125 shown in FIG. 1. The method begins by inputting learned latent topics and learned labeled dimensions of the data that have been processed by embodiments of the L+LDA model and analysis module 115 (box 400). Next, a determination is made as to whether the data being processed is a latent topic or a labeled topic (box 410). If the topic is a labeled topic, then embodiments of the model 125 heuristically assign a 4S label to the labeled topics (box 420). For example, in some embodiments a hashtag may be associated with the substance label. If the topic is a latent topic, then an operator manually assigns a 4S label to the latent topic (box 430).

Note that when assigning the 4S labels to the labeled topics that labels used in the topic labeling may be used. For example, it is known that all posts that are replies or are directed to specific users are, to some extent, social, so embodiments of the 4S label module 125 count usage of any reply or @user label as usage of the social category. Emoticons are usually indicative of a particular style, a social intent, or both. Because hashtags are intended to be indexed and re-found, they might naturally be labeled as substance. Although not all labels fall cleanly into the assigned categories, the great majority of usage of each label type is appropriately categorized as listed above, allowing the 4S label space to be expanded without manual annotation.

In some embodiments of the module 125 the topics are labeled with one of the 4S labels (box 440). These labels include a substance label, a social label, a status label, and a style label. Each of these 4S labels is discussed in detail below. In other embodiments of the module 125 other types of 4S labels may be used. Embodiments of the 4S label module 125 then output the resultant learned topic representation of the data augmented with the 4S labels (box 450).

### III.C. Data Organization Module

Embodiments of the latent topic labels text mining system 100 and method include a data organization module 130 that can characterize, summarize, filter, find, suggest, and compare the content of microblog posts. In particular, embodiments of the data organization module 130 aggregate the learned topic representation of module 125 to characterize large-scale trends in microblog posts as well as patterns of individual usage.

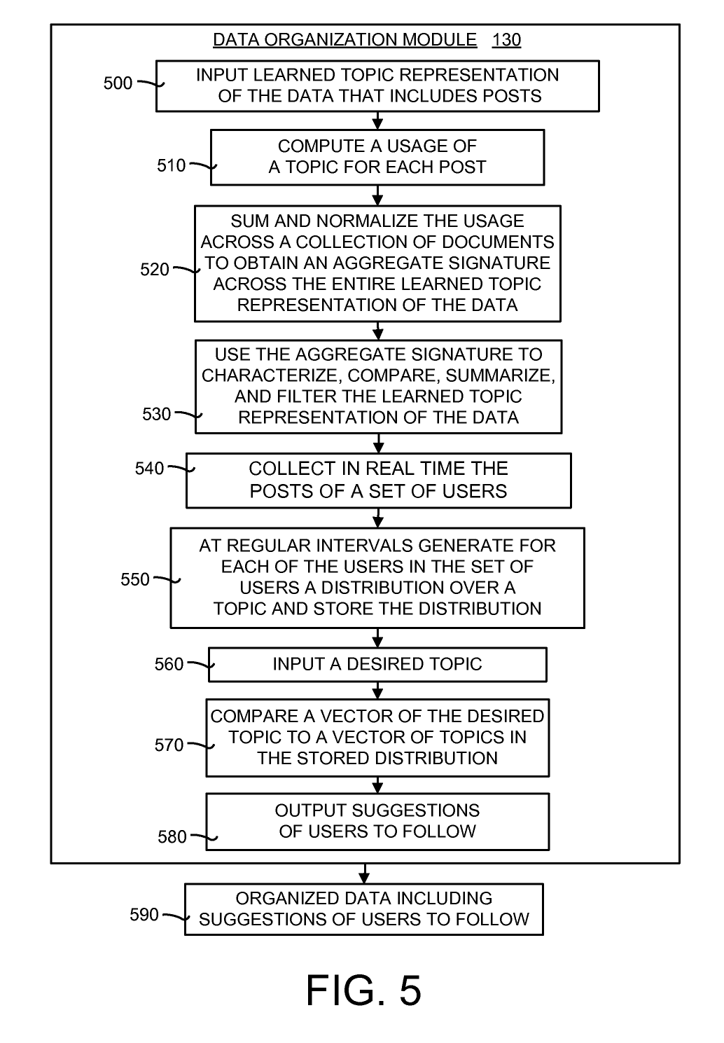

FIG. 5 is a flow diagram illustrating the operational details of embodiments of the data organization module 130 shown in FIG. 1. The method begins by inputting the learned topic representation learned from data containing posts (box 500). For new posts, usage of each learned topic is computed (box 510). Mathematically, a post d's usage of topic k, denoted θ_{d,k} is computed simply as #dk/|d|. Embodiments of the module 130 then compute an aggregate signature for any collection of posts by summing and normalizing #_{dk} across a collection of documents (box 520), such as posts written by a user, followed by a user, the result set of a query, and so forth. The usage of any 4S category can be determined by summing across the topics with each 4S label.

By aggregating across the whole dataset, embodiments of the module 130 can present a large-scale view of what people post on a microblogging site. The aggregate signature allows embodiments of the data organization module 130 to characterize, compare, summarize, and filter the data (box 530). In some embodiments this can be applied to a microblogging site.

Embodiments of the module 130 also collect data in real time to suggest and find people to follow on a microblogging site. There are processes that run in the background that are updated regularly. In order to suggest people to follow, embodiments of the module 130 collect the microblog posts of a certain set of users (box 540). In some embodiments the set is determined as a set of users having more than 1000 followers. These posts are collected in real time using a process that is running in the background. At regular intervals embodiments of the module 130 use another process that examines these collected posts from these users. For each user a distribution is generated over the topic and stored (box 550).

When a user is looking for people to follow, the user selects one or more topics in which he is interested (box 560) and then embodiments of the module 130 compare the vector of topics that the user is interested in to a vectors of topics of the people for which embodiments of the module 130 have been collecting data (box 570). A suggestion of users to follow then is output (box 580). In alternate embodiments, a topic or topics of interest also can be selected by providing a set of example microblog posts and using the topic model vector from these example microblog posts to perform the match. The complete output of embodiments of the data organization module 130 is organized data including suggestion of users to follow (box 590).

### III.D. Visualization Module

Embodiments of the latent topic labels text mining system 100 and method include a visualization module 140 that facilitates the visualization of the organized data mined from the text. In general, embodiments of the visualization module 140 takes the distribution of topics associated with an individual, a set of microblog posts, or a set of search results (which is a set of microblog posts that match a search query), and present them to a user in a visual manner based on the results of the L+LDA technique.

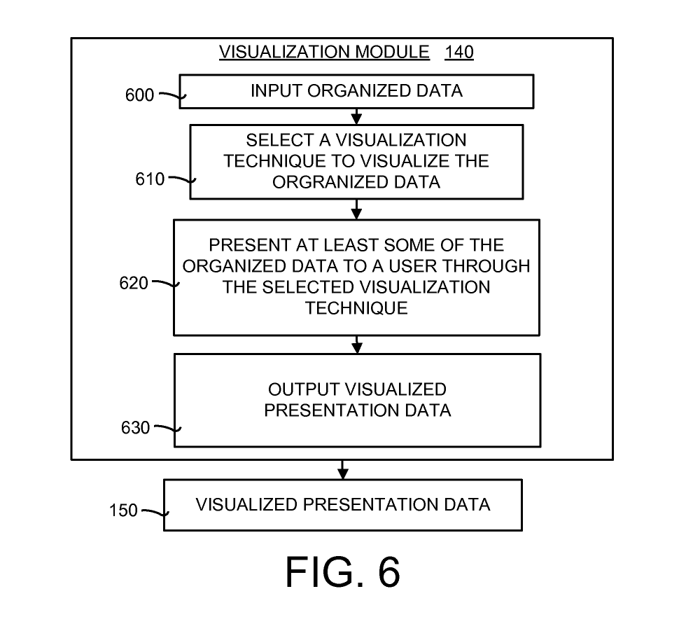

FIG. 6 is a flow diagram illustrating the operational details of embodiments of the visualization module 140 shown in FIG. 1. The method begins by inputting the organized data (box 600). Next, a visualization technique is selected that will visualize the organized data (box 610). One example of a visualization technique is given below. Embodiments of the method then present at least some of the organized data to a user through the selected visualization technique (box 620). The visualized presentation data 150 then is output (box 630).

### III.E. Interaction Module

Embodiments of the latent topic labels text mining system 100 and method include an interaction module 160 that facilitates the visualization of the organized data mined from the text. For example, suppose that a user wants to compare a group of people based on what topics characterize those people. To put all the information in one static image might be overwhelming in complexity. Embodiments of the interaction module 160 allow the user to hover over a certain area of the visualization to highlight certain aspects of it.

In many applications, it is insufficient to show only a small number of topics. Methods for showing a high-level overview of many topics, with additional details available on demand, are developed. For example, hovering over a particular topic will highlight the subset of words in the topic that this particular person uses. Also, when a user is comparing multiple people the user can control the order in which topics representing the person are shown. In some embodiments, the topics would be ordered using a primary person (as selected by the user or the system 100) and everyone else shares this topic order. Embodiments of the interaction module 160 also allow the user to select another primary person to determine the order in which topics are presented. This process of reordering and resorting can be repeated as desired.

### IV. Exemplary Operating Environment

Embodiments of the latent topic labels text mining system 100 and method are designed to operate in a computing environment. The following discussion is intended to provide a brief, general description of a suitable computing environment in which embodiments of the latent topic labels text mining system 100 and method may be implemented.

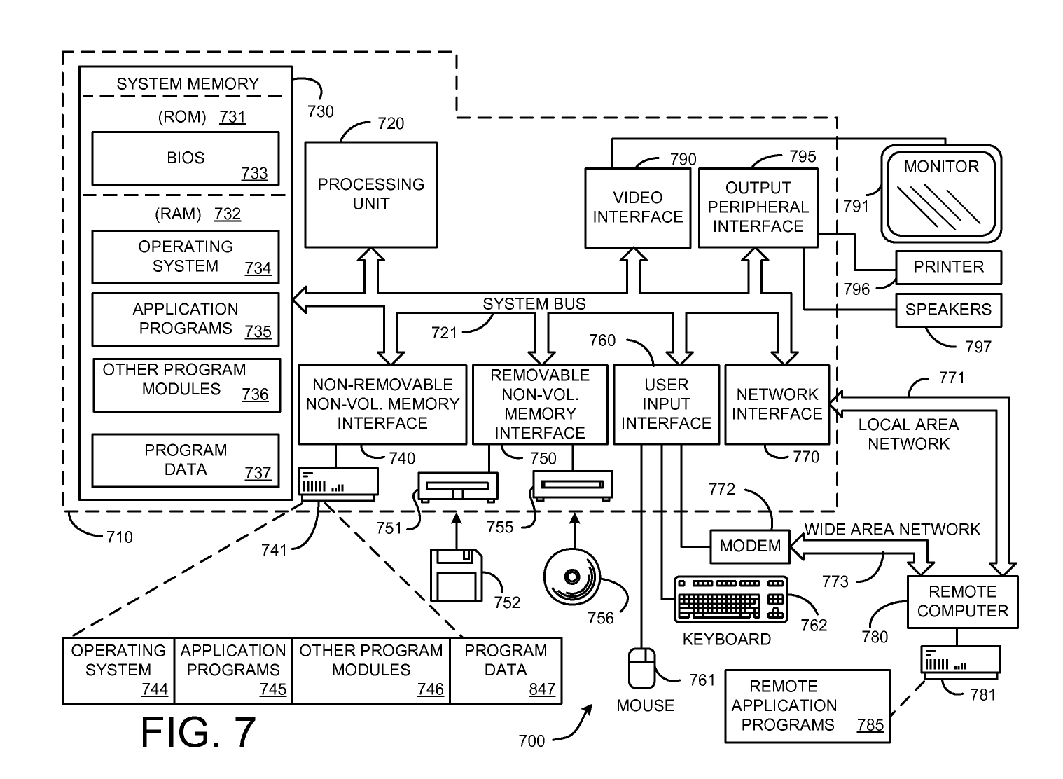

FIG. 7 illustrates an example of a suitable computing system environment in which embodiments of the latent topic labels text mining system 100 and method shown in FIGS. 1-6 may be implemented. The computing system environment 700 is only one example of a suitable computing environment and is not intended to suggest any limitation as to the scope of use or functionality of the invention. Neither should the computing environment 700 be interpreted as having any dependency or requirement relating to any one or combination of components illustrated in the exemplary operating environment.

Embodiments of the latent topic labels text mining system 100 and method are operational with numerous other general purpose or special purpose computing system environments or configurations. Examples of well known computing systems, environments, and/or configurations that may be suitable for use with embodiments of the latent topic labels text mining system 100 and method include, but are not limited to, personal computers, server computers, hand-held (including smartphones), laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Embodiments of the latent topic labels text mining system 100 and method may be described in the general context of computer-executable instructions, such as program modules, being executed by a computer. Generally, program modules include routines, programs, objects, components, data structures, etc., that perform particular tasks or implement particular abstract data types. Embodiments of the latent topic labels mining system 100 and method may also be practiced in distributed computing environments where tasks are performed by remote processing devices that are linked through a communications network. In a distributed computing environment, program modules may be located in both local and remote computer storage media including memory storage devices. With reference to FIG. 7, an exemplary system for embodiments of the latent topic labels text mining system 100 and method includes a general-purpose computing device in the form of a computer 710.

Components of the computer 710 may include, but are not limited to, a processing unit 720 (such as a central processing unit, CPU), a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 710 typically includes a variety of computer readable media. Computer readable media can be any available media that can be accessed by the computer 710 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 710. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within the computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7, provide storage of computer readable instructions, data structures, program modules and other data for the computer 710. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information (or data) into the computer 710 through input devices such as a keyboard 762, pointing device 761, commonly referred to as a mouse, trackball or touch pad, and a touch panel or touch screen (not shown).

Other input devices (not shown) may include a microphone, joystick, game pad, satellite dish, scanner, radio receiver, or a television or broadcast video receiver, or the like. These and other input devices are often connected to the processing unit 720 through a user input interface 760 that is coupled to the system bus 721, but may be connected by other interface and bus structures, such as, for example, a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 795.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

The foregoing Detailed Description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A method for mining patterns from text data, comprising:
analyzing content of the data using an augmented Labeled Latent Dirichlet Allocation (L+LDA) technique that uses a combination of labeled and unlabeled data;
generating a learned topic representation of the data using the labeled and unlabeled data; and
organizing the data using the learned topic representation; and
presenting the organized data to a user, where the organized data represents text that was mined from the data.

2. The method of claim 1, further comprising generating the labeled data by using labels provided by users prior to processing by the L+LDA technique so that different labels are used to focus on different dimensions of the data

3. The method of claim 2, further comprising using a list of user-provided labels that include one or more of a hashtag label, an emoticon-specific label, an @user label, a reply label, and a question label.

4. The method of claim 1, further comprising:
manually grouping the learned topic representation of the data after processing by the L+LDA technique to obtain groupings; and
assigning 4S labels to the groupings.

5. The method of claim 4, further comprising using the 4S labels that include one or more of a substance label, a social label, a status label, and a style label to label groupings and generate labeled data.

6. The method of claim 4, further comprising heuristically assigning the 4S labels to labeled topics in the groupings.

7. The method of claim 4, further comprising manually assigning 4S labels to latent topics in the groupings.

8. The method of claim 1, further comprising using visualization and interaction techniques to view and interact with the organized data.

9. A method for analyzing content of a microblogging system, comprising:
input data containing microblog posts;
analyzing the content using an augmented Labeled Latent Dirichlet Allocation (L+LDA) technique having a combination of labeled and unlabeled topics to obtain learned labeled topics and learned latent topics;
generating a learned topic representation of the data using the labeled topics and the latent topics; and
characterizing, comparing, summarizing, and filtering the data using the learned topic representation to organize the data and obtain organized data; and
presenting the organized data in a textual form and a visual form to illustrate the content of the microblogging system.

10. The method of claim 9, further comprising:
computing a topic distribution for each microblog post; and
aggregating topic distributions across a collection of posts to obtain a topic representation for subsets of posts or for content of the microblogging system as a whole.

11. The method of claim 10, further comprising using the aggregate signature to characterize, compare, summarize, and filter the learned topic representation of the data.

12. The method of claim 9, further comprising:
collecting in real time microblog posts of a set of users;
generating for each user in the set of users at regular intervals a distribution over topics to obtain a topic distribution; and
storing the topic distribution.

13. The method of claim 12, further comprising:
selecting a desired topic distribution of interest;
comparing a vector of the desired topic distribution of interest to the stored topic distribution to obtain a suggestion of users to follow; and
outputting the suggestions of users to follow.

14. The method of claim 9, further comprising:
manually grouping the learned topic representation of the data after processing by the L+LDA technique to obtain groupings;
assigning 4S labels to the groupings using one of four 4S labels: (1) a substance label; (2) a social label; (3) a status label; (4) a style label.

15. The method of claim 14, further comprising heuristically assigning one of the 4S labels to a labeled topic in the groupings.

16. The method of claim 14, further comprising manually assigning one of the 4S labels to a latent topic in the groupings.

17. A method for visualizing and interacting with analyzed content from a microblogging system, comprising:
obtaining the analyzed content using an augmented Labeled Latent Dirichlet Allocation (L+LDA) technique that has a combination of labeled and latent topics;
organizing the analyzed content in order to characterize, compare, summarize, filter, find, and suggest to obtain organized data;
visualizing subsets of the organized data that are associated with an individual, a set of microblog posts, or a set of search results, which is a set of microblog posts that match a search query, to obtain visualized presentation data; and
presenting the visualized presentation data to a user.

18. The method of claim 17, further comprising:
aggregating topic distributions across a set of microblog posts to obtain the visualized presentation data; and
using a tag cloud visualization to present at least some of the visualized presentation data to the user in order to visually summarize language usage for a set of posts or to contrast language usage for the two sets of posts.

19. The method of claim 18, further comprising:
a first set of stacked vertical segments on the tag cloud visualization that represents the different labels corresponding to a first microblogging account;
a second set of stacked vertical segments on the tag cloud visualization that represents the different labels corresponding to a second microblogging account; and
an overall ratio bar on the tag cloud visualization that is a vertical bar illustrating usage of the first microblogging account and the second microblogging account.

20. The method of claim 19, further comprising:
using a size of a word in the tag cloud visualization to represent an importance of a particular word in the analyzed content; and
using shading of a word in the tag cloud visualization to represent words in the topic that are used by the microblogging account.
